(19) United States
(12) Patent Application Publication
(10) Pub. No.: US 2011/0147477 A1
(43) Pub. Date: Jun. 23, 2011

(54) Fluid diversifying apparatus and method

(76) Inventor: Hoi Kwan Henry Mang, Shatin (HK)

(21) Appl. No.: 12/653,876

(22) Filed: Dec. 18, 2009

(51) Int. Cl. B05B 1/16; B05B 1/18

(52) U.S. Cl. 239/11; 239/455; 239/558; 4/615

(57) ABSTRACT

A fluid diversifying apparatus includes a fluid passage member having a fluid passage therewithin, and a fluid diversifying unit communicatively connected to the fluid passage for dispensing fluid with predetermined spray pattern. The fluid diversifying unit has a plurality of fluid selection inlets and a plurality of fluid dispensing portions communicatively connected to each of respective the fluid selection inlets for dispensing a spray pattern of the fluid through each of the dispensing portions, such that when one of the fluid selection inlet is selectively aligning with the fluid passage outlet, the fluid flow is guided to enter selected the fluid selection inlet to dispense fluid from respective the fluid dispensing portion, so as to selectively control the spray pattern from one of the fluid dispensing portions.

### BACKGROUND OF THE PRESENT INVENTION

1. Field of Invention

The present invention relates to a fluid diversifying apparatus, and more particularly to a water diversifying apparatus for houseware fluid appliance.

2. Description of Related Arts

Fluid diversifying apparatus is commonly used at home or public for showering, watering, or washing purposes. Take the water diversifying apparatus of shower head as example. The shower head is commonly used in a shower room to guide the water flow for taking a shower. The shower head can distribute water for showering more efficiently by using same amount of water to wet a relatively larger area, so as to save the water for conservation of water resource.

Generally, shower head is connected to hot and/or cold water supply sources to mix the hot and cold water to a desired shower temperature. A shower switch is adapted for manipulating the water spraying out from the shower head. There is a common type of switch, which is adapted for being pulled to turn on the shower head to start the water flow, and then, being rotated to adjust the water to desired temperature.

However, for the above type of shower head, there is no way to adjust the water spraying patterns, such as a stronger spray pattern for message the body of the user, or wider spray pattern for wet a relatively larger area. When a user wants to have variety of spray patterns, the shower head is unable to meet the requirement of needs.

In order to provide a variety of spray patterns in one shower head, there are some shower heads are provided for achieving the above purpose. The shower head with adjustable spray patterns may comprises tons of elements to divide the single shower head into a plurality of water pathways, so that the user is able to selectively adjust the spray patterns by guiding the water flow from the water passage to one of the water pathways, so as to create respectively variety of spray patterns.

One of the main concerns of the above type of adjustable spray patterns shower head is the extremely complicated structure. The plenty of individually elements for assembling the shower head not only complicate the assembling process, but also requires a relatively more sealing rings to prevent the water leaking between two of the elements of the shower heads.

The sealing rings may be worn out to decrease the performance of the shower head or water diversifying apparatus. The complicated structure is another issue of disassembling. When the sealing rings or other elements are broken, or any impurity of the water is stuck in the shower head, it is tremendous difficult to break down the shower head for maintenance purposes, so as to decrease the life time of the shower head. The user may have to get a new shower head to replace the original one.

Therefore, there exists a great need of a convenient method for selectively adjusting the water spray patterns of the shower head or other fluid diversifying head, such as for watering garden.

### SUMMARY OF THE PRESENT INVENTION

An object of the present invention is to provide a fluid diversifying apparatus, which is able to adjustably select a spray pattern of fluid dispensed out of the fluid diversifying apparatus.

Another object of the present invention is to provide a fluid diversifying apparatus, wherein no complicated structure or tons of elements are involved in assembling the diversifying apparatus. In other words, the present invention requires minimum components to reduce the manufacturing cost and process of the apparatus and to reduce the malfunction of the apparatus.

Another object of the present invention is to provide a fluid diversifying apparatus, wherein a net ring is provided for replacing conventionally plurality of o-rings or sealing rings, so as to simplify the overall structure. Accordingly, the net ring can simplify the structural configuration of the sealing rings to provide simple and effective sealing effect for the apparatus.

Another object of the present invention is to provide a fluid diversifying apparatus, wherein the disc-like shaped fluid diversifying member minimizes the bulkiness of the diversifying apparatus while maximizing the dispensing surface of the dispensing head. The variety of fluid pathways is pre-formed at the fluid diversifying member to guide the flow of fluid so as to minimize the unnecessary components of the apparatus.

Accordingly, in order to accomplish the above objectives, the present invention provides a fluid diversifying apparatus, which comprises a fluid passage member having a fluid passage therewithin, and a fluid diversifying unit communicatively connected to the fluid passage for dispensing fluid with predetermined spray pattern.

The fluid diversifying unit has a plurality of fluid selection inlets and a plurality of fluid dispensing portions communicatively connected to each of respective the fluid selection inlets for dispensing a spray pattern of the fluid through each of the dispensing portions, such that when one of the fluid selection inlet is selectively aligning with the fluid passage outlet, the fluid source is guided to enter selected the fluid selection inlet to dispense fluid from respective the fluid dispensing portion, so as to selectively control the spray pattern from one of the fluid dispensing portions.

A net-ring is preferably provided between the fluid passage outlet of the fluid passage member and the fluid diversifying unit at a position encircling each of the fluid selection inlet, such that the fluid source is able to be guided from the fluid passage outlet to pass through one of selected the fluid selection inlet to prevent the fluid source leaking between the fluid passage outlet and the fluid selection inlet.

Alternatively, in stead of providing the net-ring, a plurality of sealing rings may alternatively provided for encircling each of the peripheral edges of the fluid selection inlets.

A method of fluid diversifying may further provided, which comprises the steps of followings.

(a) Guide the fluid source within the fluid passage from the fluid passage inlet to at least one fluid passage outlet.

(b) Select one of fluid selection inlets to align with the fluid passage outlet.

(c) Guide the fluid source from the selected fluid selection inlet to one of respective fluid dispensing portions for dispensing fluid source therefrom, so as to generate a predetermined spray pattern with respect of each of dispensing portions.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a fluid diversifying apparatus according to a preferred embodiment of the present invention.

FIG. 2 is an exploded sectional view of the fluid diversifying apparatus according to the preferred embodiment of the present invention.

FIG. 3 is a sectional view of the fluid diversifying apparatus according to the preferred embodiment of the present invention.

FIG. 4 is an exploded view of the fluid diversifying unit according to the preferred embodiment of the present invention.

FIG. 5 is a rear view of the diversifying member of the fluid diversifying apparatus according to the above preferred embodiment of the present invention, illustrating the fluid pathways of the diversifying member.

FIG. 6 is a rear view of the fluid selection switch of the fluid diversifying apparatus according to the above preferred embodiment of the present invention, illustrating the net-ring mounting at the fluid selection inlets.

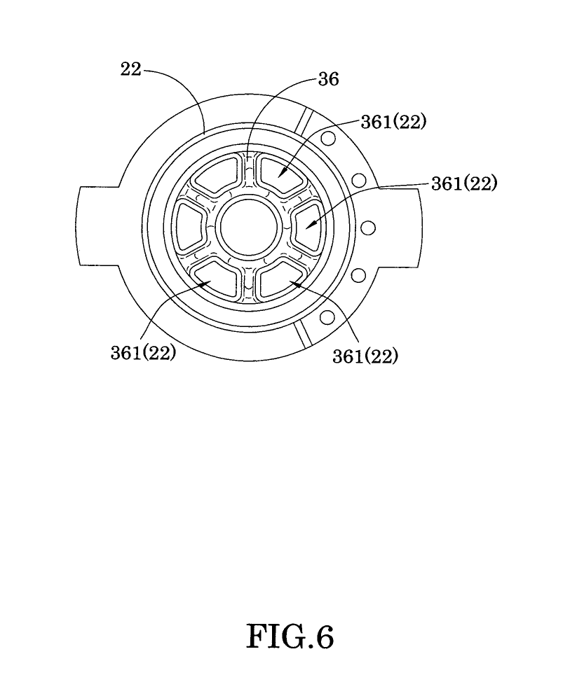

FIG. 7 illustrates the fluid diversifying apparatus incorporating with an alternative mode of the fluid passage member according to the above preferred embodiment of the present invention.

FIG. 8 is a flow chart of a method of fluid diversifying apparatus according to another preferred embodiment of the present invention.

### DETAILED DESCRIPTION OF THE PREFERRED EMBODIMENT

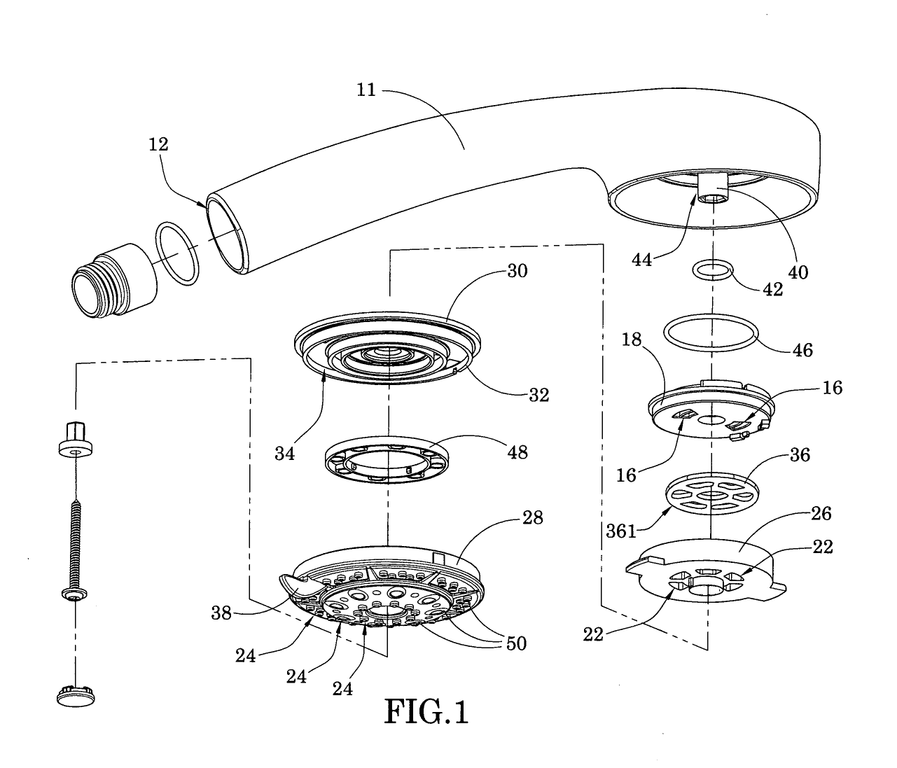

Referring to FIGS. 1 to 3 of the drawings, a fluid diversifying apparatus according to a preferred embodiment of the present invention is illustrated, wherein the fluid diversifying apparatus for effectively diversifying a flow of fluid into different spray patterns. According to the preferred embodiment, the fluid diversifying apparatus is embodied as a shower head to effectively diversify a water flow into different spray patterns.

Accordingly, the fluid diversifying apparatus comprises a fluid passage member 10 having a fluid passage 12 extended therewithin for communicatively connecting to a fluid source and a fluid diversifying unit 20 communicatively connecting to the fluid passage member 10 for controllably diversifying the fluid flow from the fluid passage 12, so as to selectively dispense the fluid source with a plurality of spray patterns from the fluid diversifying unit 20.

The fluid passage 12 has a fluid passage inlet portion 14 at one end of the fluid passage 12 for communicatively connecting to the fluid source and at least a fluid passage outlet 16 provided at an opposed end portion of the fluid passage 12. Therefore, the fluid passage 12 is able to guide the fluid flow passing from the fluid passage inlet 14 to the fluid passage outlet 16.

In particularly, the fluid passage member 10 comprises a housing 11 provided for rotatably receiving the fluid diversifying unit 20 to communicatively link with the fluid passage 12. The fluid passage member 10 further comprises a passage base 18 disposed within the housing 11 for coaxially coupling with the fluid diversifying unit 20. The fluid passage outlets 16 are preferably formed at the passage base 18, such that the passage base 18 guides the fluid flow source to enter the fluid diversifying unit 20 through the fluid passage outlets 16. The fluid passage outlets 16 are radially and symmetrically formed at the passage base 18.

According to the preferred embodiment, the housing 11 is embodied as a shower head housing having a head cavity to rotatably receive the fluid diversifying unit 20 and a handle portion, wherein the fluid passage 12 is extended from the handle portion to the head cavity to guide the water flowing to the fluid diversifying unit 20.

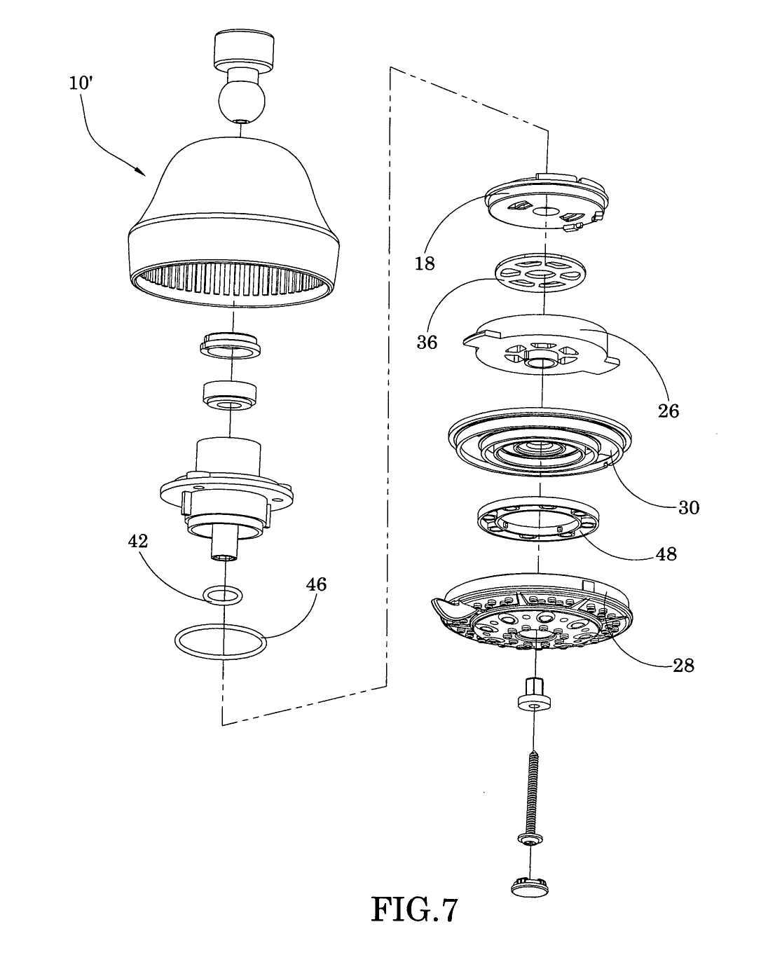

It is appreciated that the fluid passage member 10 can be a hand-held shower head as shown in FIG. 1 or the fluid passage member 10′ can be an overhead shower head as shown in FIG. 7. Therefore, the fluid diversifying apparatus can be incorporated with different devices to effectively diversify a flow of fluid into different spray patterns.

The fluid diversifying unit 20 has a plurality of fluid selection inlets 22 for selectively aligning with the fluid passage outlets 16, and a plurality of dispensing portions 24, so that when one or more of the fluid selection inlets 22 are selected to align with the fluid passage outlets 16, the fluid flow is allowed to enter the selected fluid selection inlet 22 through the fluid passage outlets 16. The fluid selection inlets 22 further guides the entered fluid source to one or more of the respective dispensing portions 24 for spraying the respective spray patterns, such that the spray patterns is able to be adjustably selected via the fluid diversifying unit 20.

In other words, the fluid diversifying unit 20 is rotatably and coaxially coupling with the passage base 18, so that the fluid diversifying unit 20 is able to rotatably and selectively align the desired fluid selection inlets 22 with the fluid passage outlet 16, so as to controllably adjust the spray pattern of the fluid diversifying apparatus.

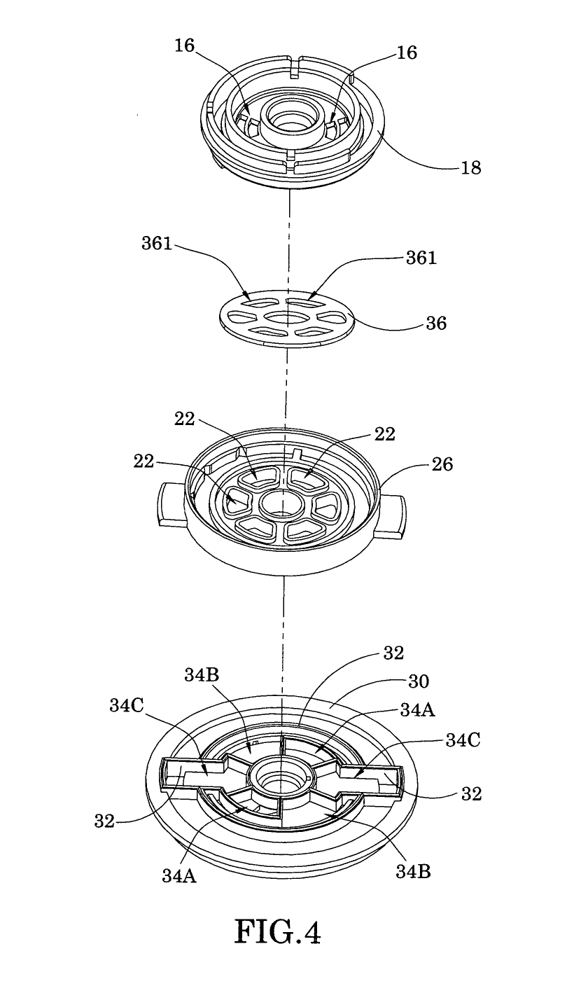

According to the preferred embodiment, the fluid diversifying unit 20 further comprises a fluid selection switch 26, a dispensing head 28, and a diversifying member 30 being sandwiched therebetween, as shown in FIG. 4, wherein the fluid selection inlets 22 is formed at the fluid selection switch 26, which is rotatably and coaxially coupling with the passage base 18, to be selectively aligned with the fluid passage outlets 16 formed at the passage base 18.

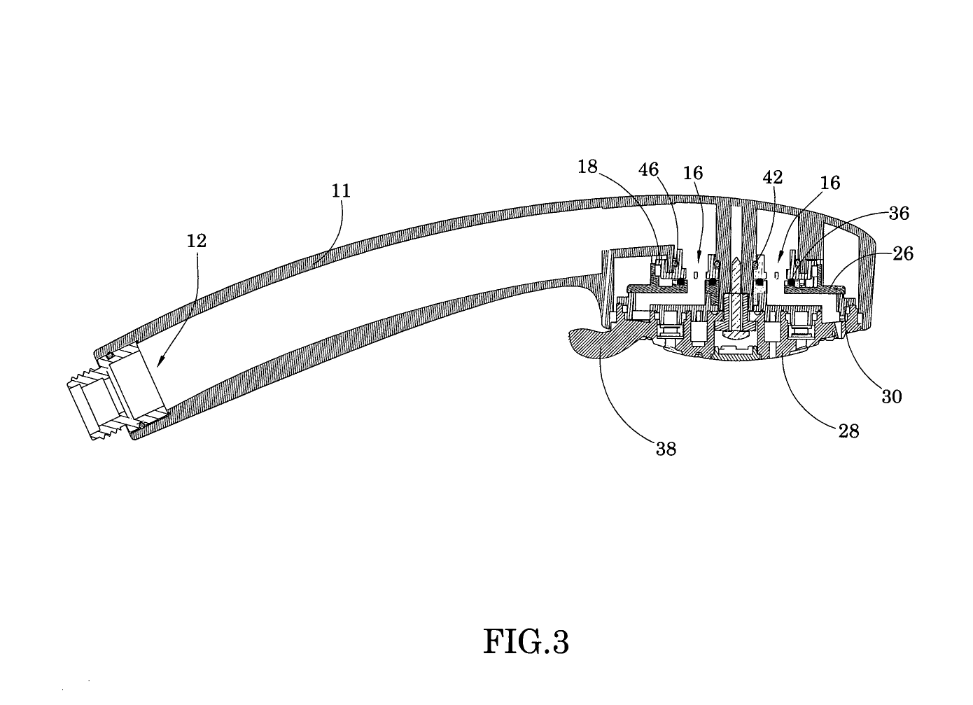

The diversifying member 30 comprises a plurality of dividing walls 32 radially and outwardly protruded out of a surface of the diversifying member 30 towards the fluid selection inlets 22 of the fluid selection switch 26 to define a plurality of fluid pathways 34 thereon, as shown in FIG. 3, wherein each of the fluid pathways 34 is communicating with respective fluid selection inlet 22 for guiding the fluid source to the selected fluid selection inlets 22 to the respective fluid pathway 34. In other words, each of the fluid pathways 34 is designated to guide the fluid flow running from the fluid selection inlet 22 to the corresponding fluid dispensing portion 24 so as to selectively control a spray pattern from the respective fluid dispensing portion 24.

The dispensing portions 24 are formed at the dispensing head 28 communicating with each of the respective fluid pathways 34, such that each of the fluid pathways 34 guides the fluid flowing from fluid selection inlets 22 to the respective dispensing portions 24 for dispensing respective spray pattern therethrough. Accordingly, the dispensing head 28 has a plurality of circular portions defining the dispensing portions 24 thereat respectively. In other words, the fluid flow is guided to among the inner circular portion, mid-circular portion, and outer circular portion of the dispensing head 28 for generating different spray pattern thereof.

Accordingly, the diversifying member 30 preferably has a substantially disc-like shape coaxially coupling with the fluid selection switch 26 and the dispensing head 28 at the position being sandwiched therebetween. Thus, the selection switch 26 and dispensing head 28 preferably has the substantially corresponding disc-like shape for coaxially coupling with the diversifying member 30, so that the diversifying unit 20 is formed to rotatably and coaxially coupling with the passage base 18, so as to rotatably and selectively switch the fluid selection inlets 22 at the fluid selection switch 26 to align with the fluid passage outlets 16.

Therefore, a dispensing surface of the disc-like shaped dispensing head 28 formed via the dispensing portions 24 is maximized while minimizing the entirely volume of the diversifying unit 20. It is worth to mention that the enlarged dispensing surface is able to be dispensed therefrom to wet a relatively lager area, so as to provide the dispensing portions 24 for generating variety of the spray patterns.

The dividing wall 32 is able to integrally form at the surface of the disc-like shaped diversifying member 30 to individually communicate with each of the respective fluid selection inlets 22, such that when the fluid selection switch 26 is selectively rotated to align with the selected fluid selection inlets 22 with the fluid passage outlets 16, the fluid flow is dispensed out of the dispensing portion 24 at the dispensing head 28 with the respect of the selected fluid selection inlets 22. Therefore, there are no tons of elements or complicated connections of assembling involved in the structure of the fluid diversifying apparatus, so as to minimize the cost and enhance the durability of the fluid diversifying apparatus.

It is worth to mention that the disc-like shaped diversifying member 30 not only minimizes the overall volume of the fluid diversifying apparatus, but also simplified the overall structure of the fluid diversifying unit 20 for dispensing variety of spray patterns from each of the dispensing portions 24, as shown in FIG. 3.

It is appreciated that the diversifying member 30 could be any other shapes, such as rectangular, eclipse, or irregular shape that is able to form the fluid pathways 34 and conforms with the shape of the fluid selection switch 26 and the dispensing head 28 for guiding the fluid source from the selection inlets 22 to the respective dispensing portions 24, though the disc-like shaped diversifying member 30 enhance the diversifying unit 20 to be smoothly rotated to select the spray patterns.

As described above, the fluid passage outlet 16 at the passage base 18 is preferred to eccentrically form at the passage base 18 to eccentrically align with the fluid selection inlet 22 at the fluid selection switch 26, which is coaxially align with the passage base 18, so that the fluid selection inlets 22 are able to be rotated to selectively align with the fluid passage outlets 16, so as to controllably adjust the spray patterns. In other words, the fluid passage outlet is eccentrically provided at the passage base 18, which is coaxially coupling at a center portion of the fluid diversifying unit 20 to be aligned with the selection inlets 22, so that the fluid is able to be guided to enter the center portion of the fluid diversifying unit 20 via the selection inlets 22 to diversely flow to each of the dispensing portions 24 through the fluid pathways 34.

In other words, the fluid selection inlets 22 are located symmetrically and radially at the fluid selection switch 26 to selectively align with the fluid passage 12. In addition, the fluid pathways 34 are radially extended with respect to a center of the diversifying member 30 to guide the fluid flow from the fluid selection inlet 22 of the fluid selection switch 26 to the fluid dispensing portion 24 of the dispensing head 28. In other words, when the fluid flow enters into the fluid pathway 34 from the respective fluid selection inlet 22, the fluid flow will radially and outwardly pass along the fluid pathway 34 to the respective dispensing portion 24 of the dispensing head 28.

In order to efficiently guide the fluid flow entering the fluid selection inlets 22, the present invention further comprises a sealing element sealed and mounted at the fluid selection switch 26 to encircle with each of the fluid selection inlets 22 for ensuring the fluid flow passing to the corresponding fluid selection inlet 22 so as to prevent the fluid flow being leaked to other the fluid selection inlets 22 which are not aligned with the fluid passage 12.

According to the preferred embodiment, the sealing element comprises a net-ring 36 provided at the fluid selection switch 26 to encircle the peripheral edges of the fluid selection inlets 22 at a position substantially between the fluid passage outlets 16 and the fluid selection inlets 22, so that the fluid is able to be sufficiently guided to enter the selected fluid selection inlets 22, so as to prevent the leaking between the fluid passage outlet 16 and the fluid selection inlet 22.

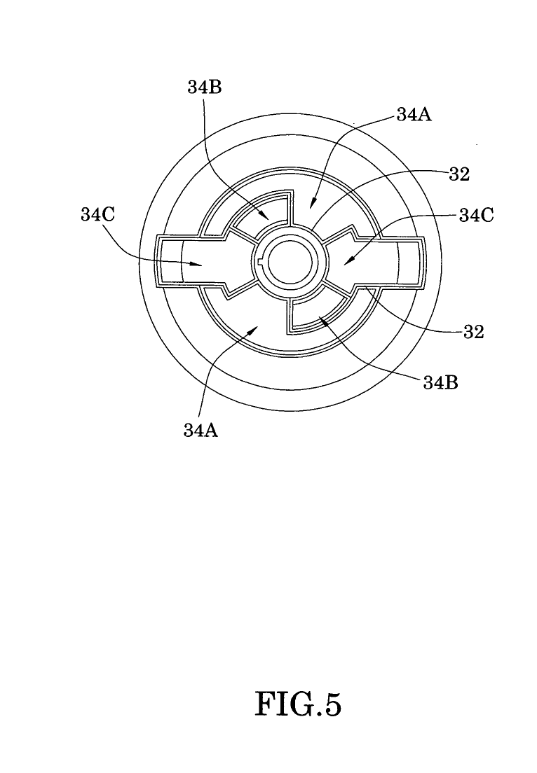

As shown in FIG. 5, the net-ring 36 has net shape substantially conforming the peripheral edges of the plurality of the fluid selection inlets 22, which is formed at a surface of the fluid selection switch 26, to integrally form a one piece net-ring 36, so as to simplify the assembling steps of the fluid diversifying apparatus.

In particularly, the net-ring 36, which is made of sealing material, has a grid-like structure and defines a plurality of sealing meshes 361 encircling with the fluid selection inlets 22 respectively to face towards the fluid passage 12. Accordingly, the sealing meshes 361 are symmetrically and radially located to seal with the fluid selection inlets 22 respectively.

It is worth mentioning that the net-ring 36 efficiently improved the drawbacks of the traditional fluid diversifying apparatus which normally has a plurality of O-rings involved in traditional complicated assembling structure used in the connections between varieties of elements for forming the fluid diversifying channels, such as traditional shower head with selectable spray pattern function. The plurality of traditional O-rings are also tends to be worn out, so that when one of the sealing rings are broken, the complicated water diversifying shower head may have to be dissembled in order to replace the O-rings. It is time consuming to assemble the complicated structure after replaced the broken O-rings.

The fluid passage outlets 16 are embodied as two passage outlets 16 symmetrically and eccentrically formed at the passage base 18 for aligning with two of respective fluid selection inlets 22 to guide the fluid flow to the corresponded dispensing portion 24 for spraying respective spray pattern. The fluid selection inlets 22 are embodied as six thereof symmetrically and eccentrically formed at the selection switch 30, wherein a pair of the diagonal fluid selection inlets 22 is selectively and concurrently aligned with the two of the fluid passage outlets 16. Each pairs of the diagonal fluid selection inlets 22 is communicating with the respective fluid pathway 34, such that the fluid diversifying unit 20 is able to be selectively rotated for guiding the fluid to enter into the respective dispensing portion 24 for spraying the spray pattern.

As shown in FIG. 4, there are totally three pairs of fluid pathways 34 (A, B, C) formed at the diversifying member 30, which are radially and outwardly projected from the fluid selection outlets 22. Accordingly, each pair of fluid pathways 34 is identical and symmetrical.

It is appreciated that the shape and amount of the fluid passage outlets 16 and fluid selection inlets 22 could be any other shapes or amount of the fluid selection inlets 22 having corresponding shapes for selectively and rotatably aligning with the fluid passage outlets 16, so as to guide the fluid to flow to the predetermined dispensing portion 24. There may be only one fluid passage outlet 16 is provided to eccentrically align with one of the selection inlets 22 for being guided to each of respective dispensing portions 24.

Accordingly, a plurality of apertures 50 are further provided at the dispensing head 28, wherein the apertures 50 are formed at each of the dispensing portions 24 for the fluid source flow out of the apertures 50. The apertures 50 preferably have variety of sizes and shapes and are arranged to form each of said individual dispensing portions 24 at the dispensing head 28 for dispensing the variety of spray patterns.

An actuation member 38 may further provided for conveniently applying a force for rotatably selecting the spray patterns via rotating the fluid diversifying unit 20. As will be readily appreciated by one skilled in the art, the actuation member 38 is preferably provided at a peripheral edge of the fluid diversifying unit 20 for applying the torque force to rotate the fluid diversifying unit 20, so as to selectively align the fluid selection inlets 22 with the fluid passage outlets 16. More specifically, the actuation member 38 is provided at the peripheral edge of the dispensing head 28, so as to more efficiently applying the torque force thereon.

Accordingly, an axis 40 is extended from a surrounding wall of the housing in order to coaxially coupling the passage base 18 with the fluid diversifying unit 20, wherein the a first sealing ring 42 is preferably provided between the axis 40 and the passage base 18. A supporting wall 44 may further extended outwardly from the surrounding wall of the housing to form a cavity between the axis 40 and the supporting wall 44 to communicatively connect with the fluid passage 12, so that when the passage base 18 is coaxially coupling at the axis 40 and coupling to the supporting wall 44 to cover the cavity therebetween, the fluid source is guided to flow from the fluid passage 12 to the fluid passage outlets 16 at the passage base 18.

Therefore, a second sealing ring 46 may further provided between the supporting wall 44 and a peripheral edge of the passage base 18, such that the first and second sealing ring 42, 46 are provided to ensure the fluid source flows only from the fluid passage 12 to the fluid passage outlet 16.

A sealing device 48 may further provided between the fluid diversifying member 30 and the dispensing head 28 to guide the fluid flows from the fluid pathway 34 to the respective dispensing portion 24, so as to efficiently dispense the fluid with the predetermined spray pattern.

It will be readily appreciated that only one net-ring 36 are required in the entirely structure of the fluid diversifying apparatus, so as to minimize the worn out rate of the net-ring 36 to prolong the life time of the apparatus. The fluid source is delivered from the selected fluid selection inlets 22 to the respective dispensing portion 24 simply via the fluid pathways 34, so that no complicated assembling structure is involved, so as to minimize the manufacturing cost.

It is appreciated that the sealing element can be formed by a plurality of individual sealing rings sealed at the peripheral edges of the fluid selection inlets 22 at a position substantially between the fluid passage outlets 16 and the fluid selection inlets 22, wherein each of the individual sealing rings has a shape substantially conforming the peripheral edge of each of the fluid selection inlets 22, so that the sealing rings are able to completely being guided into the respective fluid pathways 34 of the diversifying member 30. However, the individual sealing rings will complicated the manufacturing process and cost of the present invention.

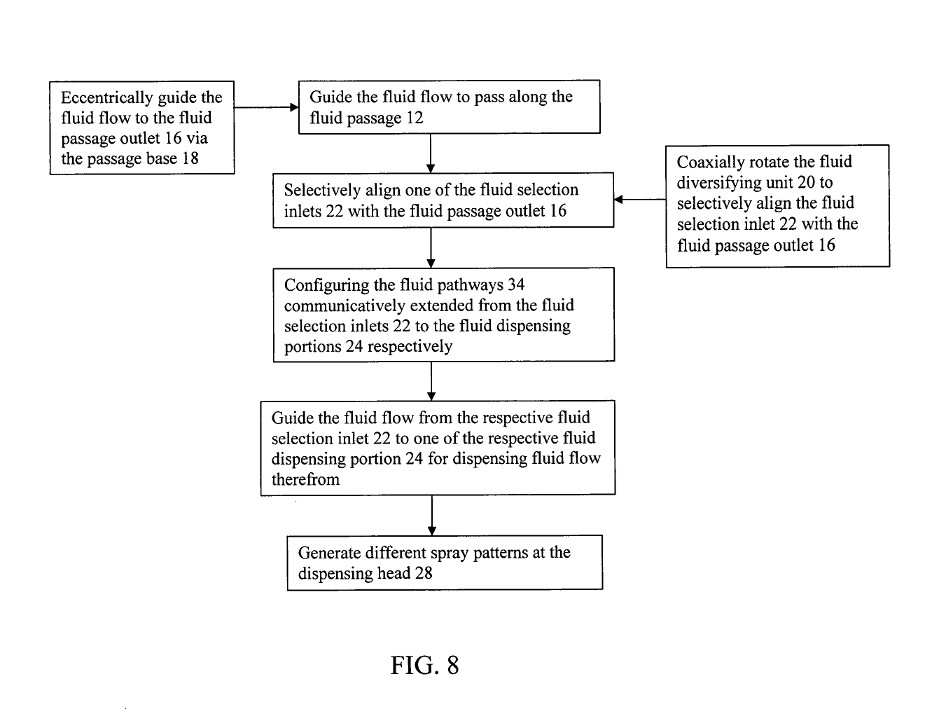

Referring to FIG. 8 of the drawings, a method of fluid diversifying according to the preferred embodiment of the present invention is illustrated, wherein the method comprises the steps of the followings.

(a) Guide the fluid flow to pass along the fluid passage 12 from the fluid passage inlet 14 to at least one fluid passage outlet 16.

(b) Selectively align one of the fluid selection inlets 22 with the fluid passage outlet 16.

(c) Configuring the fluid pathways 34 communicatively extended from the fluid selection inlets 22 to the fluid dispensing portions 24 of the fluid diversifying unit 20 respectively, wherein the fluid pathways 34 are radially and outwardly projected from the fluid selection inlets 22 respectively.

(d) Guide the fluid flow from the respective fluid selection inlet 22 to one of the respective fluid dispensing portion 24 for dispensing fluid flow therefrom, so as to generate a predetermined spray pattern.

Accordingly, the step (a) further comprises a step of eccentrically guiding the fluid flow to the fluid passage outlet 16 via the passage base 18, wherein the passage outlets 16 are radially formed at the passage base 18 for communicatively guiding the fluid flow to enter into the selection inlets 22.

As mentioned above, at the step (b), the fluid diversifying unit 20 is coaxially and rotatably moved to selectively align the fluid selection inlet 22 with the fluid passage outlet 16, wherein the fluid selection inlets 22 are located radially to selectively align with the fluid passage 12 when the fluid diversifying unit 20 is driven to rotate.

In the step (c), the fluid flow is guided to pass from the fluid selection inlet 22 to the respective fluid dispensing portion 24 of the dispensing head 28 through the designated fluid pathway 34. In particularly, the fluid flow is guide to flow radially and outwardly along the fluid pathway 34 at the diversifying member 30.

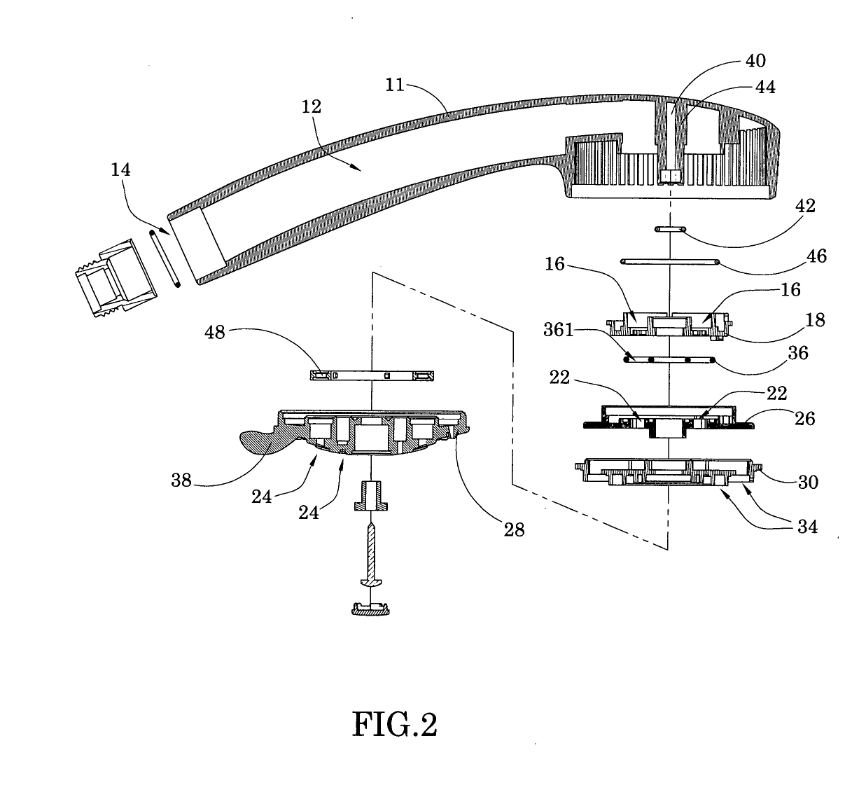

It is appreciated that the fluid diversifying apparatus can be used as a shower head as shown in FIGS. 1 and 2 of the drawings. In addition, the fluid diversifying apparatus can be used as a water sprinkler for watering the garden, a faucet for bathroom, laundry or kitchen, or a spraying nozzle connecting to a water pipe. It is worth mentioning that by incorporating a motorized device with the fluid diversifying unit 20, the fluid diversifying unit 20 can be selectively controlled to be rotated with respect to the fluid passage member 10 for generating different spray patterns. For example, when the present invention incorporates with the water sprinkler, the fluid diversifying apparatus can be automatically switched the spray patterns in a timely manner via the motorized device and a timer.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fluid diversifying apparatus, comprising:
a fluid passage member having a fluid passage adapted for guiding a flow of fluid passing therethrough;
a fluid diversifying unit having a plurality of fluid selection inlets and a plurality of fluid dispensing portions communicatively linked with said fluid selection inlets respectively, wherein when one of said fluid selection inlets is selectively aligned with said fluid passage, said fluid diversifying unit is adapted for guiding said fluid flow to run at said respective fluid dispensing portion so as to selectively control a spray pattern from said respective fluid dispensing portions; and
a net-ring provided between said fluid passage outlet of said fluid passage member and said fluid diversifying unit at a position that said net-ring is sealed and encircled each of said fluid selection inlets for ensuring said fluid flow passing to said corresponding fluid selection inlet so as to prevent said fluid flow being leaked to other said fluid selection inlets which are not aligned with said fluid passage.

2. The fluid diversifying apparatus, as recited in claim 1, wherein said net-ring, which is made of sealing material, has a grid-like structure and defines a plurality of sealing meshes encircling with said fluid selection inlets respectively.

3. The fluid diversifying apparatus, as recited in claim 1, wherein said fluid diversifying unit further has a plurality of fluid pathways communicatively extended from said fluid selection inlets to said fluid dispensing portions respectively, such that each of said fluid pathways is designated to guide said fluid flow running from said fluid selection inlet to said corresponding fluid dispensing portion.

4. The fluid diversifying apparatus, as recited in claim 2, wherein said fluid diversifying unit further has a plurality of fluid pathways communicatively extended from said fluid selection inlets to said fluid dispensing portions respectively, such that each of said fluid pathways is designated to guide said fluid flow running from said fluid selection inlet to said corresponding fluid dispensing portion.

5. The fluid diversifying apparatus, as recited in claim 1, wherein said fluid diversifying unit, which is rotatably coupled with said fluid passage member, comprises a fluid selection switch defining said fluid selection inlets thereat, and a dispensing head defining said fluid dispensing portions thereat, such that when said dispensing head is rotated, said fluid selection switch is rotated correspondingly to selectively align said one of said fluid selection inlets with said fluid passage.

6. The fluid diversifying apparatus, as recited in claim 3, wherein said fluid diversifying unit, which is rotatably coupled with said fluid passage member, comprises a fluid selection switch defining said fluid selection inlets thereat, and a dispensing head defining said fluid dispensing portions thereat, such that when said dispensing head is rotated, said fluid selection switch is rotated correspondingly to selectively align said one of said fluid selection inlets with said fluid passage.

7. The fluid diversifying apparatus, as recited in claim 4, wherein said fluid diversifying unit, which is rotatably coupled with said fluid passage member, comprises a fluid selection switch defining said fluid selection inlets thereat, and a dispensing head defining said fluid dispensing portions thereat, such that when said dispensing head is rotated, said fluid selection switch is rotated correspondingly to selectively align said one of said fluid selection inlets with said fluid passage.

8. The fluid diversifying apparatus, as recited in claim 5, wherein said net-ring is sealed and mounted at said fluid selection switch to face towards said fluid passage.

9. The fluid diversifying apparatus, as recited in claim 6, wherein said net-ring is sealed and mounted at said fluid selection switch to face towards said fluid passage.

10. The fluid diversifying apparatus, as recited in claim 7, wherein said net-ring is sealed and mounted at said fluid selection switch to face towards said fluid passage.

11. The fluid diversifying apparatus, as recited in claim 7, wherein said fluid diversifying unit further comprises a diversifying member being sandwiched between said fluid selection switch and said dispensing head and defining said fluid pathways at said diversifying member to communicate between said fluid selection inlets and said fluid dispensing portions correspondingly.

12. The fluid diversifying apparatus, as recited in claim 10, wherein said fluid diversifying unit further comprises a diversifying member being sandwiched between said fluid selection switch and said dispensing head and defining said fluid pathways at said diversifying member to communicate between said fluid selection inlets and said fluid dispensing portions correspondingly.

13. The fluid diversifying apparatus, as recited in claim 11, wherein said diversifying member comprises a plurality of dividing walls integrally and radially protruded towards said fluid selection switch to defines said fluid pathways along said dividing walls respectively.

14. The fluid diversifying apparatus, as recited in claim 12, wherein said diversifying member comprises a plurality of dividing walls integrally and radially protruded towards said fluid selection switch to defines said fluid pathways along said dividing walls respectively.

15. The fluid diversifying apparatus, as recited in claim 1, wherein said fluid selection inlets are located symmetrically and radially to selectively align with said fluid passage.

16. The fluid diversifying apparatus, as recited in claim 4, wherein said fluid selection inlets are located symmetrically and radially to selectively align with said fluid passage.

17. The fluid diversifying apparatus, as recited in claim 14, wherein said fluid selection inlets are located radially to selectively align with said fluid passage.

18. A fluid diversifying apparatus, comprising:
a fluid passage member having a fluid passage adapted for guiding a flow of fluid passing therethrough; and
a fluid diversifying unit, which is rotatably coupled with said fluid passage member, comprising:
a fluid selection switch defining a plurality of fluid selection inlets thereat to selectively align with said fluid passage;
a dispensing head coupling with said fluid selection switch and defining a plurality of fluid dispensing portions for communicating with said fluid selection inlets respectively; and
a diversifying member being sandwiched between said fluid selection switch and said dispensing head, wherein said diversifying member has a plurality of fluid pathways communicatively extended from said fluid selection inlets to said fluid dispensing portions respectively, wherein when one of said fluid selection inlets is selectively aligned with said fluid passage, said respective fluid pathway is designated to guide said fluid flow running from said fluid selection inlet to said corresponding fluid dispensing portion so as to selectively control a spray pattern from said respective fluid dispensing portions.

19. The fluid diversifying apparatus, as recited in claim 18, wherein said fluid pathways are radially extended with respect to a center of said diversifying member to guide said fluid flow from said fluid selection inlet of said fluid selection switch to said fluid dispensing portion of said dispensing head.

20. The fluid diversifying apparatus, as recited in claim 18, wherein said diversifying member comprises a plurality of dividing walls integrally and radially protruded towards said fluid selection switch to defines said fluid pathways along said dividing walls respectively.

21. The fluid diversifying apparatus, as recited in claim 19, wherein said diversifying member comprises a plurality of dividing walls integrally protruded towards said fluid selection switch to defines said fluid pathways along said dividing walls respectively.

22. The fluid diversifying apparatus, as recited in claim 18, wherein said fluid selection inlets are located symmetrically and radially to selectively align with said fluid passage.

23. The fluid diversifying apparatus, as recited in claim 21, wherein said fluid selection inlets are located symmetrically and radially to selectively align with said fluid passage.

24. The fluid diversifying apparatus, as recited in claim 18, wherein each of said fluid selection switch, said diversifying member, and said dispensing head has a substantially disc-like shape coaxially coupling with each other at a position that said diversifying member is sandwiched between said dispensing head and said fluid selection switch.

25. The fluid diversifying apparatus, as recited in claim 23, wherein each of said fluid selection switch, said diversifying member, and said dispensing head has a substantially disc-like shape coaxially coupling with each other at a position that said diversifying member is sandwiched between said dispensing head and said fluid selection switch.

26. The fluid diversifying apparatus, as recited in claim 18, wherein said fluid passage member comprises a housing for said fluid diversifying unit rotatably coupling thereat, wherein said fluid passage has a fluid passage inlet adapted for linking with a fluid source, and at least a fluid passage outlet extended from said fluid passage inlet at a position radially located at said housing to selectively align with one of said fluid selection outlets of said fluid selection switch.

27. The fluid diversifying apparatus, as recited in claim 25, wherein said fluid passage member comprises a housing for said fluid diversifying unit rotatably coupling thereat, wherein said fluid passage has a fluid passage inlet adapted for linking with a fluid source, and at least a fluid passage outlet extended from said fluid passage inlet at a position radially located at said housing to selectively align with one of said fluid selection outlets of said fluid selection switch.

28. The fluid diversifying apparatus, as recited in claim 18, further comprising a sealing element sealed and mounted at said fluid selection switch to encircle with each of said fluid selection inlets for ensuring said fluid flow passing to said corresponding fluid selection inlet so as to prevent said fluid flow being leaked to other said fluid selection inlets which are not aligned with said fluid passage.

29. The fluid diversifying apparatus, as recited in claim 23, further comprising a sealing element sealed and mounted at said fluid selection switch to encircle with each of said fluid selection inlets for ensuring said fluid flow passing to said corresponding fluid selection inlet so as to prevent said fluid flow being leaked to other said fluid selection inlets which are not aligned with said fluid passage.

30. The fluid diversifying apparatus, as recited in claim 27, further comprising a sealing element sealed and mounted at said fluid selection switch to encircle with each of said fluid selection inlets for ensuring said fluid flow passing to said corresponding fluid selection inlet so as to prevent said fluid flow being leaked to other said fluid selection inlets which are not aligned with said fluid passage.

31. A method for diversifying a fluid flow via a fluid diversifying apparatus which comprises a fluid passage member and a fluid diversifying unit, comprising the steps of:
(a) guiding said fluid flow along a fluid passage of said fluid passage member;
(b) selectively aligning at least one of fluid selection inlet of said fluid diversifying unit with said fluid passage; and
(c) configuring a plurality of fluid pathways communicatively extended from said fluid selection inlets to a plurality of fluid dispensing portions of said fluid diversifying unit respectively, wherein said fluid pathways are radially and outwardly projected from said fluid selection inlets respectively;
(d) guiding said fluid flow from said respective fluid selection inlet to one of fluid dispensing portion of said fluid diversifying unit through said designated fluid pathway for generating a predetermined spray pattern thereat.

32. The method as recited in claim 31 wherein, in the step (b), said fluid diversifying unit is coaxially rotated to selectively align said fluid selection inlet with said fluid passage.

33. The method, as recited in claim 31, further comprising a step of sealing and mounting a net-ring between said fluid passage outlet of said fluid passage member and said fluid diversifying unit at a position that said net-ring is sealed and encircled each of said fluid selection inlets for ensuring said fluid flow passing to said corresponding fluid selection inlet so as to prevent said fluid flow being leaked to other said fluid selection inlets which are not aligned with said fluid passage.

34. The method, as recited in claim 32, further comprising a step of sealing and mounting a net-ring between said fluid passage outlet of said fluid passage member and said fluid diversifying unit at a position that said net-ring is sealed and encircled each of said fluid selection inlets for ensuring said fluid flow passing to said corresponding fluid selection inlet so as to prevent said fluid flow being leaked to other said fluid selection inlets which are not aligned with said fluid passage.

35. The method, as recited in claim 33, wherein said net-ring, which is made of sealing material, has a grid-like structure and defines a plurality of sealing meshes encircling with said fluid selection inlets respectively.

36. The method, as recited in claim 34, wherein said net-ring, which is made of sealing material, has a grid-like structure and defines a plurality of sealing meshes encircling with said fluid selection inlets respectively.

37. The method, as recited in claim 31, wherein said fluid diversifying unit comprises a fluid selection switch defining said fluid selection inlets thereat, and a dispensing head defining said fluid dispensing portions thereat, such that when said dispensing head is rotated, said fluid selection switch is rotated correspondingly to selectively align said one of said fluid selection inlets with said fluid passage.

38. The method, as recited in claim 36, wherein said fluid diversifying unit comprises a fluid selection switch defining said fluid selection inlets thereat, and a dispensing head defining said fluid dispensing portions thereat, such that when said dispensing head is rotated, said fluid selection switch is rotated correspondingly to selectively align said one of said fluid selection inlets with said fluid passage.

39. The method, as recited in claim 37, wherein said fluid diversifying unit further comprises a diversifying member being sandwiched between said fluid selection switch and said dispensing head and defining said fluid pathways at said diversifying member to communicate between said fluid selection inlets and said fluid dispensing portions correspondingly.

40. The method, as recited in claim 38, wherein said fluid diversifying unit further comprises a diversifying member being sandwiched between said fluid selection switch and said dispensing head and defining said fluid pathways at said diversifying member to communicate between said fluid selection inlets and said fluid dispensing portions correspondingly.

41. The method, as recited in claim 39, wherein each of said fluid selection switch, said diversifying member, and said dispensing head has a substantially disc-like shape coaxially coupling with each other at a position that said diversifying member is sandwiched between said dispensing head and said fluid selection switch.

42. The method, as recited in claim 40, wherein each of said fluid selection switch, said diversifying member, and said dispensing head has a substantially disc-like shape coaxially coupling with each other at a position that said diversifying member is sandwiched between said dispensing head and said fluid selection switch.

43. The method, as recited in claim 31, wherein said fluid selection inlets are located symmetrically and radially to selectively align with said fluid passage.

44. The method, as recited in claim 42, wherein said fluid selection inlets are located symmetrically and radially to selectively align with said fluid passage.
